(19) United States
(12) Patent Application Publication
(10) Pub. No.: US 2014/0154354 A1
(43) Pub. Date: Jun. 5, 2014

(54) PREPARATION OF AN ALCOHOLIC BEVERAGE BASE

(71) Applicant: Daniel James Schiefen, Mooresville, NC (US)

(72) Inventor: Daniel James Schiefen, Mooresville, NC (US)

(21) Appl. No.: 13/920,871

(22) Filed: Jun. 18, 2013

Related U.S. Application Data
(60) Provisional application No. 61/690,182, filed on Jun. 21, 2012.

(51) Int. Cl. C12C 11/00

(52) U.S. Cl. CPC C12C 11/003
USPC 426/16; 426/592

(57) ABSTRACT

An alcoholic beverage base is produced by preparing wort from a glucose source and water, adding glucose to achieve desired sugar content, heating wort, cooling wort, adding yeast to the wort after cooling and then fermenting for a certain time and at a certain temperature, adding additional sugar and yeast as needed, continuing fermentation to a desired end point and separating solids therefrom. The beverage base can be made to have an alcohol content ranging from 1%-25% by volume and has a clean pleasant taste without off-aromas.

### FIELD OF THE INVENTION

The present invention relates to a process for the production of an alcoholic beverage base and to the beverages thus produced.

### BACKGROUND OF THE INVENTION

Although alcoholic beverages have been produced for many years, there remains room for improvements. For example, it would be desirable if the process could be made faster and it would be desirable if an economical process could provide a beverage base of relatively higher alcohol content. It would be particularly desirable to have a process which was both faster than conventional processes and which yielded a product having higher alcohol content.

Accordingly, the present invention, through a process of fermentation using a mash with sugar and yeast and stepped sugar additions, enables the production of a high alcoholic content beer base which itself possesses a pleasant taste and which may be used as a beverage or which may be admixed with other materials to form a beverage having a certain desired taste and color characteristics. Preferably, the sugar used in the present process is not grain-based.

Further understanding of the present invention will be had from the following specification and claims.

### SUMMARY OF THE INVENTION

An alcoholic beverage base is produced by preparing wort from a glucose source and water, adding glucose to achieve desired sugar content, heating wort, cooling wort, adding yeast to the wort after cooling and then fermenting for a certain time and at a certain temperature, adding additional sugar and yeast as needed, continuing fermentation to a desired end point and separating solids therefrom. The beverage base can be made to have an alcohol content ranging from 1%-25% by volume and has a clean pleasant taste without off-aromas.

### DESCRIPTION OF THE INVENTION

The present invention relates to a process for the production of an alcoholic beverage base and to the beverages thus produced. The present invention, through a process of fermentation using a mash with dissolved glucose and yeast, enables the production of a high alcoholic content beer base which itself possesses a pleasant taste and which may be used as a beverage or which may be admixed with other materials to form a beverage having a certain desired taste and color characteristics.

In accordance with the process of the present invention, a wort is prepared. The wort may be formed by admixing, in a mash tub or brew kettle, water, sugar, (e.g. glucose, malted grains, corn syrup, etc), a nitrogen source (e.g. diammonium phosphate) or other yeast nutrient, optionally, if needed, citric acid and/or gypsum in amounts conventional in the brewing industry to adjust to proper pH for fermentation. Preferably, glucose, corn syrup, or granular sugars or sugar syrups which are not grain-based are used.

The wort may have any sugar content up to a specific gravity of about 1.06.

Fermentable sugar, e.g., brewery corn syrups, malt extract or dextrose, is then added to the wort if necessary and the wort is heated to dissolve sugars and/or for pasteurization.

The wort is transferred to a fermenter and cooled to a temperature of 75-95 degrees F., aerated and pitched with high gravity yeast. Fermentation is thus initiated. The fermentation should be very vigorous at the start. Fermentation is continued along with a means of agitation while maintaining the temperature at a level optimal for fermentation to the desired end point. Additional sugar is added as needed as specific gravity drops below about 1.06 until desired alcohol content is achieved. Total sugar volume may be added in 1-10 additions as needed to maintain vigorous fermentation while keeping the specific gravity of the wort below about 1.06. Fermentation is complete when specific gravity falls below the desired endpoint.

At this point the yeast is separated from fermented wort. This resulting base is a clean tasting alcoholic base with no off-aromas. The alcoholic content of the base can, of course, be controlled by the length of time the fermentation is permitted to continue as well as added sugars before or during fermentation process.

In the event the base is itself to be used as the final beverage, it can be carbonated, if desired, and packaged by means well known in the art. It can be stabilized against microbiological spoilage by incorporating preservative agents prior to packaging, such agents being known in the brewing art; or, it can be subjected to pasteurizing after packaging by means also known in the art.

The alcoholic beverage base can subsequently be processed to produce beverages having various desired alcoholic content, flavor and color characteristics. This is accomplished by admixing the base with the necessary additives and/or diluents to achieve the desired final product.

The base can be carbonated according to methods which are conventional in the art, and can be flavored by the addition of various natural and/or artificial flavoring agents and colored by the addition of conventional coloring agents. Conventional flavoring agents such as fruit syrups, cola syrups, and the like can be used. If desired, agents to improve the foam properties, coloring agents, food grade acids, sweeteners and buffer salts can be added. Packaging of the final beverage and preservation against microbial spoilage are achieved by means well known in the art.

The particular amounts of the additives are not critical and are chosen to yield the particularly desired characteristics of the final product beverage sought. Further understanding of this invention will be had from the following specific example.

### EXAMPLE

This procedure provides a process for the manufacture of a clear base containing alcohol in variable amounts. This procedure can be applied to produce a clear, flavorless base containing alcohol through the process of fermentation. This base can take on any flavor and/or ingredient to produce a variety of beverages. By the term “Clear Beer Base” is meant a clear nearly flavorless alcoholic liquid brewed from the fermentation of sorghum syrup.

Addition #1:

Potable water is added to a kettle or tank and heated to a temperature of 150-170 degrees F. Water volume is 2650 gallons. BriesSweet White Sorghum Syrup 45DE (525 gallons) is added to the kettle. Specific Gravity: approx. 1.06. The resulting solution is passed through a heat exchanger and temperature is brought down to 85 degrees F. on the way to fermentation tank.

Yeast is added (5 kg Still Spirits TY48) to the fermenter at rates recommended for specific yeast strain. Oxygen may be injected into the wort if needed through a diffuser until O2 levels are approximately 8-10 ppm. Yeast is allowed to replicate at a temperature of 85 degrees Fahrenheit until specific gravity falls below 1.02.

Addition #2:

BriesSweet White Sorghum Syrup 45DE (263 gallons) is added to the fermenter. Specific Gravity will be approximately 1.02-1.05. Yeast is added to fermenter if needed. Fermentation is allowed at a temperature of 85 degrees Fahrenheit until gravity falls below 1.02.

Addition #3:

BriesSweet White Sorghum Syrup 45DE (263 gallons) is added to the fermenter. Specific Gravity will be approximately 1.02-1.05. Yeast is added to fermenter if needed. Fermentation is allowed at a temperature of 85 degrees Fahrenheit until gravity falls at or below 0 degrees Plato (SG 1.0). Final alcohol by volume should be 14.8%-15.75% depending on brewery conditions.

Yeast Culture:

Yeast cultures are kept along with fermenting beer base for additions as needed in fermentation process.

Fermenter Specs:

Constant agitation and temp control is best achieved through a recirculation system on fermentation tanks. Beer is drawn from tank by a pump and passed through a heat exchanger, then recirculated back into fermenter(preferably at an angle on tank outer diameter for a whirlpooling effect).

While preferred embodiments of the present invention have been disclosed in the foregoing disclosure, the present invention is subject to variation and modification within the broad scope of the invention. Therefore, it will be appreciated by those skilled in the art that the present invention is intended to be limited only by the scope of the following claims.

What is claimed is:

1. A method for the production of an alcoholic beverage base which comprises preparing a glucose source combined with water to obtain a wort having a sugar content of selected value, cooling the wort, initiating fermentation in the wort with yeast at a temperature ranging from about 55 to about 95 degrees F. and a pitching rate appropriate to gravity of the wort, and continuing the fermentation at temperatures appropriate for fermentation with subsequent sugar additions with agitation while maintaining an appropriate temperature for yeast performance to a desired end point, then cooling the fermented wort, separating solids therefrom to obtain a desired alcoholic beverage base having a desired alcohol content of from about 1% to about 25% ABV.

2. The method of claim 1 wherein said subsequent sugar additions are made when the wort has a specific gravity of less than 1.06.

3. The method of claim 2 wherein said glucose is from a granular sugar source.

4. The method of claim 2 wherein said glucose source is from a sugar syrup source.

5. The method of claim 1 wherein said glucose source is not grain-based.

6. An alcoholic beverage base made by a process of:
preparing a glucose source combined with water to obtain a wort having a sugar content of selected value, cooling the wort, initiating fermentation in the wort with yeast at a temperature ranging from about 55 to about 95 degrees F. and a pitching rate appropriate to gravity of the wort, and continuing the fermentation at temperatures appropriate for fermentation with subsequent sugar additions with agitation while maintaining an appropriate temperature for yeast performance to a desired end point, then cooling the fermented wort, separating solids therefrom to obtain a desired alcoholic beverage base having a desired alcohol content of from about 1% to about 25% ABV.
